(19) United States
(12) Patent Application Publication
(10) Pub. No.: US 2024/0157291 A1
(43) Pub. Date: May 16, 2024

(54) CO2 Filtration Battery Blanket

(71) Applicant: Panasonic Automotive Systems Company of America, Division of Panasonic Corporation of North America, Peachtree City, GA (US)

(72) Inventor: Alex Green, The Colony, TX (US)

(21) Appl. No.: 18/503,921

(22) Filed: Nov. 7, 2023

Related U.S. Application Data
(60) Provisional application No. 63/425,698, filed on Nov. 16, 2022.

(51) Int. Cl. B01D 53/62; B01D 53/82; H01M 50/204; H01M 50/24; H01M 50/249

(52) U.S. Cl. CPC B01D 53/62; B01D 53/82; H01M 50/204; H01M 50/24; H01M 50/249; B01D 2251/302; B01D 2251/304; B01D 2251/306; B01D 2251/404; B01D 2251/604; B01D 2253/25; B01D 2257/504; H01M 2220/20

(57) ABSTRACT

A carbon dioxide filtration arrangement for a motor vehicle includes at least one battery powering the motor vehicle. A blanket covers the battery and absorbs carbon dioxide from the ambient air. The blanket also provides fire suppression and insulation. Thus, the blanket improves the safety and performance of EV batteries.

### CROSS-REFERENCED TO RELATED APPLICATIONS

This application claims benefit of U.S. Provisional Application No. 63/425,698, filed on Nov. 16, 2022, the disclosure of which is hereby incorporated by reference in its entirety for all purposes.

### BACKGROUND OF THE INVENTION

### 1. Field of the Invention

The present invention relates to batteries of an electric vehicle.

### 2. Description of the Related Art

Internal combustion engine motor vehicles emit carbon dioxide into the air, which can harm the environment.

### SUMMARY OF THE INVENTION

The invention may provide an air filter which collects carbon dioxide (CO₂) from ambient air, and which covers and insulates the battery of an electric vehicle. The air filter may remove CO₂ from the air while also providing benefits such as fire suppression and thermal and electrical insulation. Thus, the inventive air filter may improve the safety and performance of EV batteries, while collecting CO₂ from the environment.

The filter may be in the form of a filtration blanket for EV battery cells. The thin blanket filter covers the battery platform.

The inflow of CO₂ from ambient air may be captured in a blanket-like filter over the EV batteries. The blanket not only captures CO₂ to help the environment, but also acts as an insulator and fire retardant for improved battery performance and safety.

The CO₂ can be extracted in concentrated form from the blanket at regular intervals by the end user or by some other entity. The extracted CO₂ may be valuable for other uses, such as for fuel, fertilizer, carbonated beverages, and underground storage, for example.

The invention comprises, in one form thereof, a carbon dioxide filtration arrangement for a motor vehicle, including at least one battery powering the motor vehicle. A blanket covers the battery and absorbs carbon dioxide in ambient air and emitted from other vehicles on the roadway.

The invention comprises, in another form thereof, a method for assembling, operating, and maintaining a motor vehicle, including installing at least one battery in the motor vehicle. The battery is covered with a blanket, which may or may not include a housing structure. The motor vehicle is powered by the battery. The blanket is used to absorb the carbon dioxide in ambient air and emitted from other vehicles on the roadway.

The invention comprises, in yet another form thereof, a carbon dioxide filtration arrangement for a motor vehicle, including at least one battery powering the motor vehicle. A platform supports the battery. A blanket covers the battery and at least a portion of the platform. The blanket absorbs carbon dioxide in ambient air. The blanket filtration may be flexible or rigid. For example, the blanket may be a flexible, porous textile material or a rigid mesh-like metal that allows air to pass. A housing structure may enclose said blanket, similarly to an automotive air filter, to contain airflow.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of one embodiment of a CO₂ filtration arrangement of the present invention for electric vehicle batteries.

FIG. 2a is a side view of the CO₂ filtration arrangement of FIG. 1 and a housing partially enclosing the blanket of the CO₂ filtration arrangement.

FIG. 2b is a top view of the housing and blanket of FIG. 2a.

FIG. 3 is a flow chart of one embodiment of a method of the present invention for assembling, operating, and maintaining a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

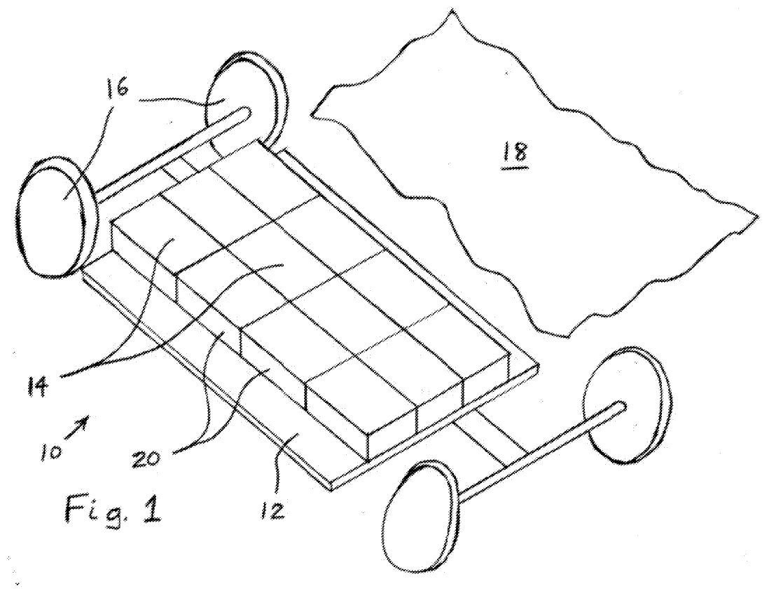

FIG. 1 illustrates one embodiment of an automotive CO₂ filtration arrangement 10 of the present invention, including a battery platform 12 supporting an array of batteries 14. Batteries 14 may power the drive train of the vehicle, as characterizes an electric vehicle. Four wheels 16 of the motor vehicle are coupled to platform 12. A carbon dioxide filtration blanket 18 is shown displaced from batteries 14, but blanket 18 covers the array of batteries 14 during use. Blanket 18 may also be large enough to cover platform 12 as well as batteries 14. Blanket 18 may be flexible or rigid enough to hang down along the vertical sides 20 of batteries 14 on all four sides of the array of batteries 14. Blanket 18 may be secured to batteries 14 and/or platform 12 by any conventional means, such as by snaps, quick connectors, zip ties, ropes, Velcro, etc.

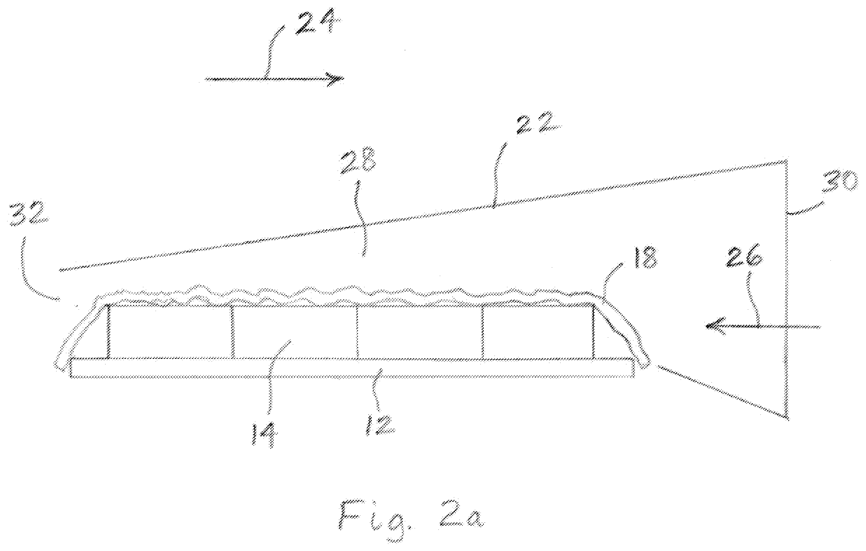

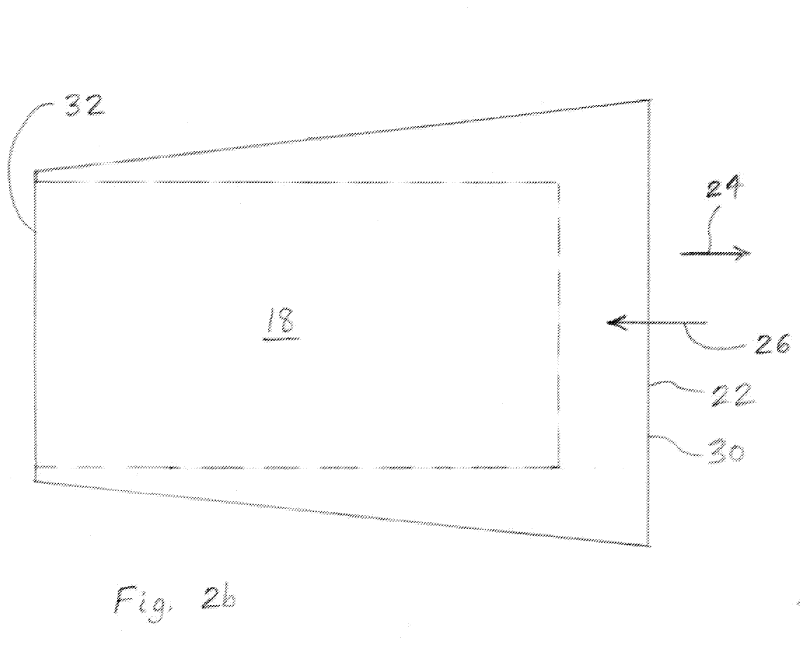

Blanket 18 may be partially enclosed by a housing structure 22 (FIGS. 2a-b) to direct airflow toward blanket 18. As the motor vehicle generally travels in a forward direction 24, ambient air generally flows in the opposite direction 26 relative to blanket 18 and housing 22, although the air flow is somewhat impeded by the body (not shown) of the motor vehicle. Housing 22 and blanket 18 may define an air flow channel 28 therebetween. Channel 28 may have an entrance 30 and an exit 32. During use, as the motor vehicle travels in forward direction 24, ambient air is funneled by housing 22 toward blanket 18 so that a greater volume of air may flow through or against blanket 18, and more carbon dioxide may thereby be absorbed by blanket 18.

Blanket 18 may be Corned of and/or impregnated with any material that can absorb carbon dioxide. Such materials include soda lime, sodium hydroxide, potassium hydroxide, and lithium hydroxide, for example.

During use, blanket 18 may cover and snugly fit over the array of batteries 14. Blanket 18 may filter out and collect carbon dioxide in the ambient air. The collected carbon dioxide may be later removed from blanket 18 so that blanket 18 may be reused on batteries 14 to filter more carbon dioxide.

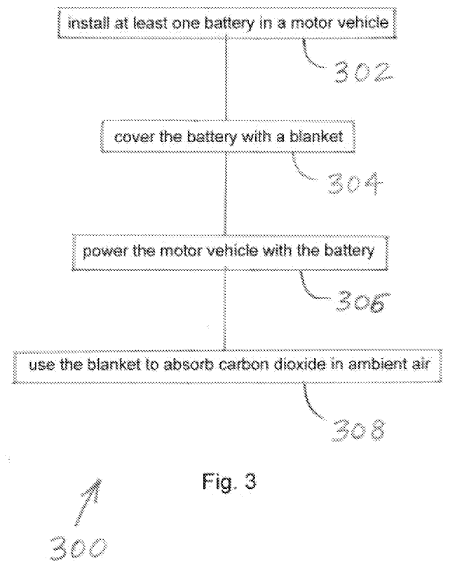

FIG. 3 illustrates one embodiment of a method 300 of the present invention for assembling, operating, and maintaining a motor vehicle. In a first step 302, at least one battery is installed in the motor vehicle. For example, batteries 14 may be installed in a motor vehicle.

In a next step 304, the battery is covered with a blanket. For example, batteries 14 may be covered with a blanket 18.

Next, in step 306, the motor vehicle is powered with the battery. For example, batteries 14 may power the motor vehicle in which they are installed, and may thereby cause the wheels of the motor vehicle to turn.

In a final step 308, the blanket is used to absorb carbon dioxide in ambient air. For example, blanket 18 may absorb carbon dioxide in ambient air flowing through channel 28.

The term “blanket” as used herein may encompass any flexible sheet of material of any thickness, but the thickness may typically be approximately between 0.25 inch and two inches. The blanket may have a length of approximately between five and fifteen feet, and a width of approximately between five and fifteen feet.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A carbon dioxide filtration arrangement for a motor vehicle, the arrangement comprising:
at least one battery configured to power the motor vehicle; and
a blanket covering the battery and configured to absorb carbon dioxide from ambient air.

2. The arrangement of claim 1 wherein the at least one battery comprises at least ten batteries.

3. The arrangement of claim 1 wherein the at least one battery is configured to power a drive train of the motor vehicle.

4. The arrangement of claim 1 further comprising a platform supporting the at least one battery.

5. The arrangement of claim 1 wherein the blanket covers at least one vertically-oriented side of the battery.

6. The arrangement of claim 1 wherein the blanket is formed of and/or impregnated with soda lime, sodium hydroxide, potassium hydroxide, and/or lithium hydroxide.

7. The arrangement of claim 1 wherein the blanket is attached to the battery.

8. A method for assembling, operating, and maintaining a motor vehicle, the method comprising:
installing at least one battery in the motor vehicle;
covering the battery with a blanket;
powering the motor vehicle with the battery; and
using the blanket to absorb carbon dioxide in ambient air.

9. The method of claim 8 wherein the at least one battery comprises at least ten batteries.

10. The method of claim 8 wherein the powering step includes powering a drive train of the motor vehicle.

11. The method of claim 8 further comprising removing the carbon dioxide from the blanket.

12. The method of claim 8 wherein the covering step includes covering at least one vertically-oriented side of the battery with the blanket.

13. The method of claim 8 wherein the blanket is formed of and/or impregnated with soda lime, sodium hydroxide, potassium hydroxide, and/or lithium hydroxide.

14. The method of claim 8 further comprising attaching the blanket to the battery.

15. A carbon dioxide filtration arrangement for a motor vehicle, the arrangement comprising:
at least one battery configured to power the motor vehicle;
a platform supporting the battery; and
a blanket covering the battery and at least a portion of the platform and configured to absorb carbon dioxide from ambient air.

16. The arrangement of claim 15 wherein the at least one battery comprises at least ten batteries.

17. The arrangement of claim 15 wherein the at least one battery is configured to power a drive train of the motor vehicle.

18. The arrangement of claim 15 wherein the blanket covers at least one vertically-oriented side of the battery.

19. The arrangement of claim 15 wherein the blanket is formed of and/or impregnated with soda lime, sodium hydroxide, potassium hydroxide, and/or lithium hydroxide.

20. The arrangement of claim 15 wherein the blanket is attached to the battery.
